(19) United States
(12) Patent Application Publication
(10) Pub. No.: US 2020/0370717 A1
(43) Pub. Date: Nov. 26, 2020

(54) LIGHTING UNITS

(71) Applicant: Paul Sparrow, Weymouth Dorset (GB)

(72) Inventor: Paul Sparrow, Weymouth Dorset (GB)

(21) Appl. No.: 16/968,269

(22) PCT Filed: Feb. 8, 2019
(86) PCT No.: PCT/GB2019/050346

§ 371 Date: Aug. 7, 2020

(30) Foreign Application Priority Data
Feb. 9, 2018 (GB) 1802202.0

(51) Int. Cl. F21L 4/04; G01C 9/32; G01C 9/28

(52) U.S. Cl. CPC F21L 4/04; G01C 9/28; G01C 9/32

(57) ABSTRACT

A lighting unit for a tool or instrument comprises a housing, a battery (100) within the housing, a bulb (103), and an electrical circuit (102) which is within the housing and connects the bulb to the battery. The housing has a switching portion (96), and a part of the circuit is mounted on the switching portion so that the switching portion (96) can be moved to open and close the circuit (102). Mounting means (90, 92) are arranged to mount the housing in the tool or instrument for rotation about an axis of rotation.

### FIELD OF THE INVENTION

The present invention relates to lighting units. It has particular application in lighting for tools and instruments, such as spirit levels but also has application in other fields where lighting of small areas is required.

### BACKGROUND TO THE INVENTION

It is known to provide lighting in spirit levels to improve the visibility of the bubble and the markings with which the bubble is aligned. Lighting in other instruments is similarly well known. However spirit levels and other instruments are often used in wet or dirty conditions and known lighting systems can become unreliable if they get damp or dirty. They are also complicated to manufacture and assemble.

### SUMMARY OF THE INVENTION

The present invention provides a lighting unit, for example for a tool or instrument, the unit comprising a housing, a battery within the housing, a bulb, and an electrical circuit which is within the housing and connects the bulb to the battery, the housing having a switching portion, and a part of the circuit being mounted on the switching portion so that the switching portion can be moved to open and close the circuit, and mounting means arranged to mount the housing for rotation about an axis of rotation.

The housing may comprise an outer wall which extends round the axis of rotation. The housing may comprise two parallel coaxial axle portions each of which is arranged to be supported in the tool or instrument. The housing may be rotatable about an axis of rotation and may have an outer wall which is curved around its axis of rotation. The lighting unit may form a thumbwheel.

The housing may further comprise a side wall which forms the switching portion. The side wall may have a cam mounted on it. The cam may have a cam surface facing in a generally axial direction of the lighting unit.

The present invention further provides a spirit level comprising a body, a bubble vial mounted in the body, and a lighting unit, wherein the lighting unit comprises a housing, a battery within the housing, a bulb, and an electrical circuit which is within the housing, the housing having a switching portion, which may be for example a flexible or otherwise movable portion, and a part of the circuit being mounted on the switching portion so that the switching portion can be moved to open and close the circuit.

The body may define an opening into which the lighting unit can be removably inserted. The opening may be shaped so as to support the lighting unit when it is inserted into the opening.

The switching portion may be movable between a first position in which it opens the circuit and a second position in which it closes the circuit. The switching portion may be arranged to be frictionally retained in each of the first and second positions. Alternatively, the switching portion may be spring biased towards the first position.

The housing may be movably mounted in the body. The housing may be movable between a first position and a second position. The body may comprise a switching surface arranged to act on the switching portion to close the circuit when the housing is in the second position.

The switching portion of the housing may have a housing cam surface formed thereon. The housing cam surface may be arranged to be acted on by the switching surface as the housing is moved from the first position to the second position, thereby to close the circuit.

The switching surface may be shaped to form a stationary cam surface and the flexible portion may have a contact surface thereon which is arranged to be acted on by the stationary cam surface as the housing is moved from the first position to the second position thereby closing the switch.

It will be appreciated that there may be a cam surface on either one of the housing and the stationary body or on both. If there are two cam surfaces they may act on each other. If there is only one, then a switching surface, which may be a simple flat surface, may be provided to act on, or be acted on by, the cam surface.

Alternatively, rather than using a cam, the switching surface may be part of, or support on, a resilient member, and may be arranged to come into contact with the switching portion of the lighting unit when the lighting unit is in the second position.

The housing may be slidably mounted in the body and arranged to slide between the first position and the second position.

Alternatively the housing may be rotatably mounted in the body and arranged to rotate between the first position and the second position. The housing may be rotatable about an axis of rotation and may have an outer wall which is curved around the axis of rotation. The curved outer wall may be at least partly exposed so that the housing can be rotated between the first and second positions by pushing the outer wall. In this way, the lighting unit may form a thumb wheel.

The housing may further comprise a side wall which may be annular and may form the flexible portion.

The lighting unit may comprise two parallel coaxial axle portions each of which is rotatably supported in the body. The bulb may be housed in one of the axle portions. The axle portion, or the whole housing, may be formed of translucent or transparent material.

The spirit level or the lighting unit may further comprise, in any workable combination, any one or more features of the preferred embodiments of the invention as will now be described with reference to the accompanying drawings.

### BRIEF DESCRIPTION OF THE DRAWINGS

FIG. 1 is a perspective view of a lighting unit forming part of a spirit level according to an embodiment of the invention;

FIG. 2 is a perspective view of the lighting unit of FIG. 1 incorporated into an internal component of a spirit level according to an embodiment of the invention;

FIG. 3 is a perspective view of part of the spirit level and lighting unit of FIG. 2 in use;

FIG. 3a is a schematic view of a modification to the spirit level of FIG. 3;

FIG. 4 is a plan view of part of a spirit level according to a further embodiment of the invention;

FIG. 5 is a perspective view of the part of the spirit level of FIG. 4;

FIG. 6 is a perspective view of a lighting unit forming part of the spirit level of FIG. 4;

FIG. 7 is a perspective view of part of the spirit level of FIG. 4 in use;

FIG. 8 is a side view of the internal components of the lighting unit of FIG. 6; and

FIG. 9 is an enlargement of part of FIG. 8.

### DESCRIPTION OF THE PREFERRED EMBODIMENTS

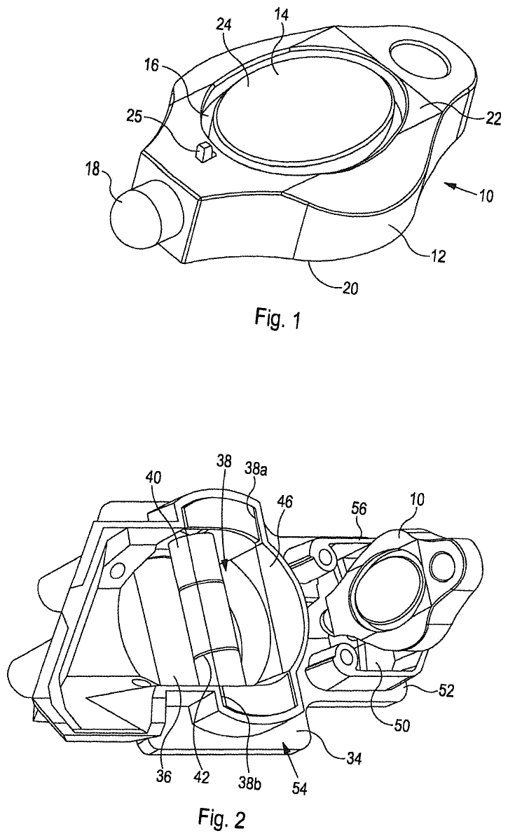

Referring to FIG. 1, a lighting unit 10 comprises a housing 12 which houses a battery and electrical circuit (not shown). The housing 12 includes a switching portion 14 which may be in the form of a push button 14, which is movable relative to the rest of the housing 12. The switching portion 14 may be formed integrally with the rest of the housing 12 and connected to it by a thin flexible connecting region 16 which extends all around the switching portion 14. A light bulb housing 18 is mounted in the housing 12 and houses a bulb which is connected to the battery by means of the electrical circuit. The housing 12 may have a flat rear surface 20 and the switching portion 14 may be arranged to form part of a front surface 22 of the housing 12. The switching portion may have a substantially flat front surface 24 which may be substantially parallel to the rear surface 20. This can enable the housing to be gripped between the finger and thumb of a user and squeezed so as to depress the switching portion relative to the rest of the housing 12. The housing 12 of the lighting unit 10 may comprise a further switch 25 which can be moved between first and second positions in which it opens and closes the electrical circuit to turn the light off and on. In this case the switch may be a sliding switch for which the first position is further way from the light bulb housing 18 than the second position. The switch 25 may be frictionally engaged so that it will remain in either of the first and second positions unless positively moved by a user. This enables the light to be turned on permanently before the lighting unit is inserted into the spirit level and left on while the level is in use with the lighting unit inserted. In a modification to this, the sliding switch may be present and form the only switching portion of the lighting unit, without the push-button switching portion 14. Also the shape and orientation of the switching portions may of course be different from those specifically shown in the drawings.

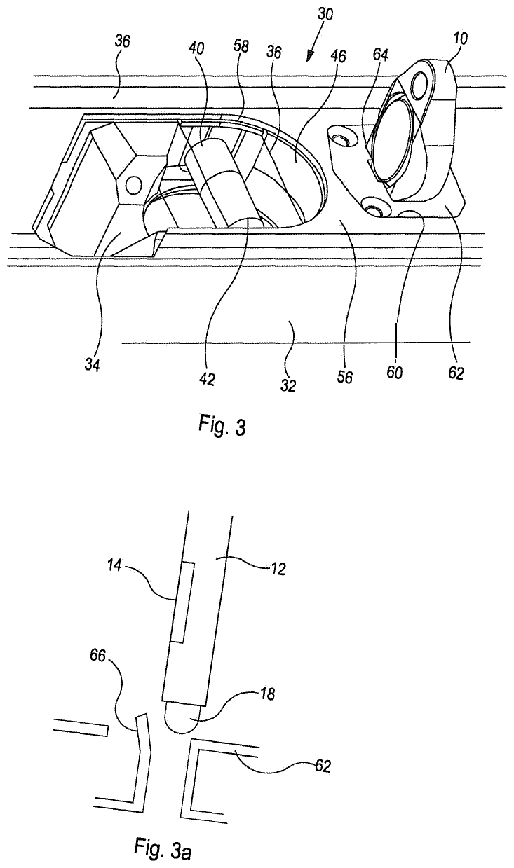

Referring to FIG. 2 and FIG. 3, a spirit level 30 comprises a body 32 which may include a vial housing 34 in which a bubble vial 36 is mounted. The vial housing 34 or cradle may be formed as a separate moulded component, for example of plastics material, supported in a metal extruded outer part of the body, as shown in FIG. 2 or may be an integral part of the main body 32 which may be die cast. The vial housing 34 defines a vial cavity 38 in which the vial 36 is mounted. For example the vial housing may define a pair of recesses 38a, 38b on opposite sides of the vial cavity 38 in which the ends of the vial 36 are supported. Typically the vial 36 is formed as a square section length of transparent plastic 38 with a liquid cavity 40 formed in it. The liquid cavity 40 is typically of circular cross section and tapers slightly towards each end and is filled with liquid and a small amount of air which forms the bubble. Markings 42 on the vial 36 are provided to identify the central location which the bubble occupies when the level is truly horizontal.

The vial housing 34 may include a wall 46 which extends around at least one side of the vial cavity 38 and separates the vial cavity 38 from a light-receiving cavity 50 in the body 32. In this case the light receiving cavity 50 of the body is partly defined by a light supporting portion 52 of an insert 54 which also forms the vial housing 34. The light supporting portion 52 of the insert 54 includes a side-wall 56 which extends around three sides of the light-receiving cavity 50, with the wall 46 of the vial cavity 38 extending between the fourth side of the light-receiving cavity 50 and the vial cavity 38. The wall 46 of the vial cavity, and optionally the whole insert 54, is formed of translucent or transparent plastics material so that when the bulb 18 of the light unit 10 is in the light-receiving cavity 50, it will illuminate the vial cavity 38 and hence the vial 40.

The top of the side walls 46, 56 are level with each other so that the top panel 56 of the body 32 can be located against them. This top panel 56 may be part of an extrusion including the side walls and bottom panel, or it may be a separate part. The cover 56 has an opening 58 in it exposing the vial cavity 38, and a further opening 60 exposing the light-receiving cavity 50. A light-supporting cover 62 is arranged to cover the opening 60 in the flat cover 56, and has an opening 64 through it arranged to receive the front end of the light unit 10 including the light bulb 18. The opening 64 may be arranged to fit closely around the body 12 of the light unit so as to support the light unit 10 in position with its bulb 18 in the light receiving cavity 50. The switching portion 14 of the light unit may be exposed when the light unit 10 is supported in the opening 64 so that a user can turn the light on and off.

If the sliding switch 25 is present, the opening 64 may be wide enough to allow the housing 12 to pass into it, but too narrow to allow the sliding switch 25 to pass into it. This means that whenever the lighting unit is pushed into position in the lighting cavity, the switch 25 will be pushed to its ‘on’ position by the surface of the cover 62 adjacent to the opening 64. When the lighting unit 10 is removed from the spirit level, the light will remain on until it is turned off by a user pushing the switch 25 to its ‘off’ position.

In a modification to this arrangement, the switch 25 may be spring-biased towards its off position, and may be arranged to be moved to its on position as described above when the lighting unit is inserted into the spirit level, but to move to its off position under the influence of the spring bias when the lighting unit is removed from the spirit level.

Referring to FIG. 3a, the light supporting cover 62 may include a resilient switching tab 66 formed integrally with it or mounted on it which is arranged to press against the switching portion 14 of the light unit 10 when the light unit 10 is fully inserted into, and supported by, the cover 62. In this case the light will be permanently turned on whenever the light unit 10 is fully inserted into the opening 64, and the lighting unit 10 can be slid in and out of the opening between its fully inserted position, in which it will be turned on, and a fully or partially retracted position, in which the switching tab 66 will cease to press on the switching portion 14 and the light will be turned off.

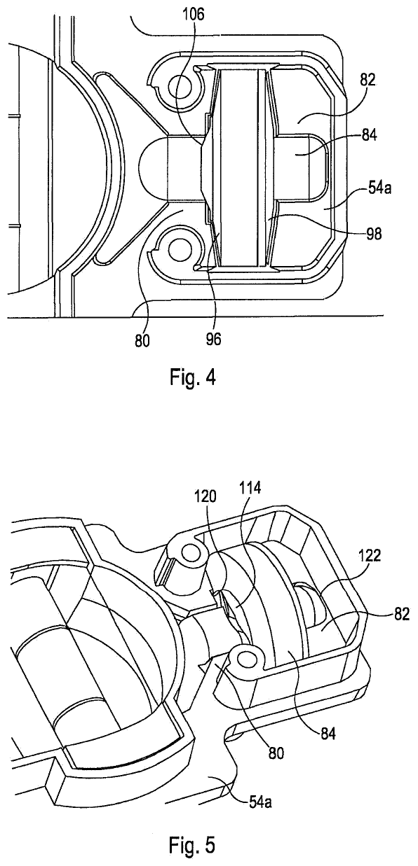

Referring to FIGS. 4 and 5, in an alternative arrangement, the lighting unit may be arranged to be permanently supported in the light-receiving cavity 50 of the spirit level. For example, the insert 54a may be similar to that 54 of FIG. 2, but may comprise two bearing portions 80, 82 which are arranged to support a rotatable lighting unit 84.

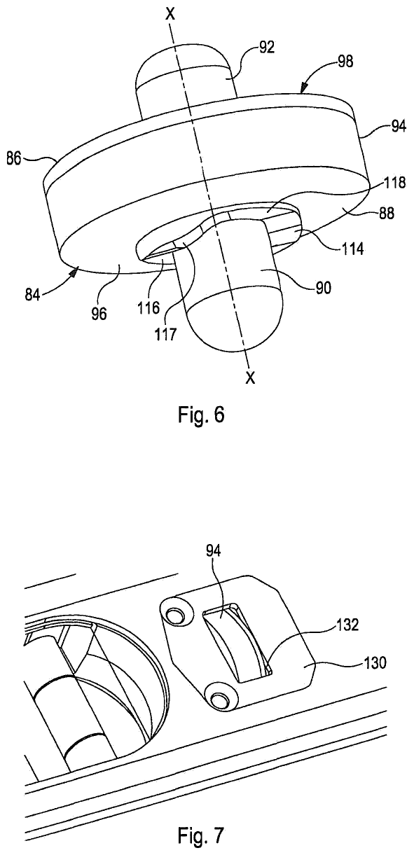

Referring also FIG. 6, the rotatable lighting unit comprises a housing 86 which includes a main part 88 which is generally cylindrical in shape having a central axis X-X and two axle parts 90, 92 extending from opposite sides of the main part 88. The axle parts 90, 92 are both of circular cross section and arranged coaxially with each other and with the main part 88 of the housing. The axle parts 90, 92 are arranged to be received and supported in the bearing portions 80, 82 of the insert 54a so as to support the lighting unit 84.

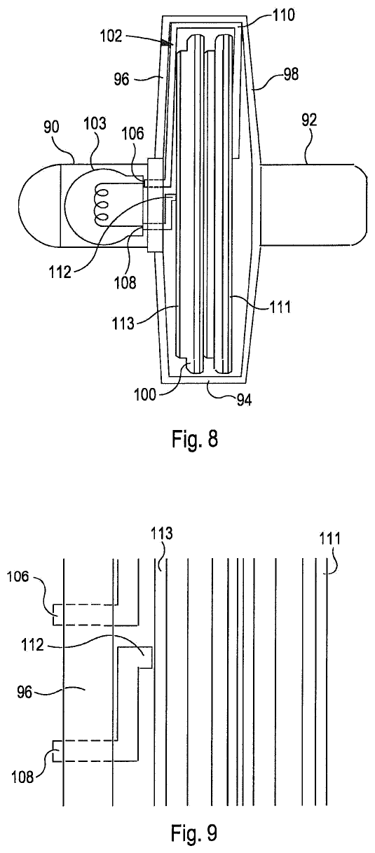

The main part 88 of the housing comprise a curved outer wall 94, which has the central axis X-X of the lighting unit 84 as its centre of curvature, and two substantially annular side walls 96, 98 connecting the edges of the outer wall 94 to the base of the respective axle parts 90, 92. Referring to FIG. 8, the housing 86 contains a battery pack 100, typically formed of one or more button cells, which is housed in the main part 88 of the housing, an electrical circuit 102, and a bulb 103 or LED which is housed in one of the axle portions 90 of the housing, or arranged to direct light into one of the axle portions 90. This one 90 of the axle portions may have a transparent end 90a through which light can be transmitted. The side of the lighting unit 84 where the bulb or LED is located may be referred to as the front of the unit, and the other side as the back. The circuit 102 includes two contacts 106, 108 arranged to make electrical contact with the contacts of the bulb 103, and a conductor 110 connecting one of the contacts 106 to a first one of the terminals 111 of the battery pack 100. The circuit further comprises a switch contact 112 which is connected to the other of the contacts 108 and arranged to be just spaced away from a second terminal 113 of the battery pack 100.

For example, as shown in FIGS. 8 and 9, the battery pack 100 may be fixed relative to one of the annular walls 98 of the housing, and the switching contact 112 may be mounted on the other of the annular walls 96 of the housing. The housing 86 may be formed of plastics or other flexible material, so that if the two annular walls 96, 98 are pushed together, the switching contact 112 will come into contact with the second terminal 113 of the battery pack.

One of the annular walls, for example the front annular wall 96, of the housing may have a cam 114 formed on it. The cam may be formed around the base of one of the axle portions 90 of the housing. The cam may be of generally annular shape and has a cam surface 116, and may vary in height, in the axial direction of the lighting unit, including one or more raised portions 117, and one or more lowered portions 118, joined by sloping portions, so that the cam surface 116 is of a varying height above the annular wall 96 in the axial direction. It will be appreciated that the cam 114 could be of a variety of shapes. For example the lower parts 118 could be omitted altogether, and only one or both of the higher parts 117 and their associated sloping portions provided.

Referring back to FIG. 5, the body of the spirit level, for example the insert 54a, may include a switching surface 120 which is arranged to act on the lighting unit 84 to turn the bulb on and off as the lighting unit is rotated in the body 32 of the spirit level. The switching surface 120 may be adjacent to one of the bearings 80, and arranged to face the cam surface 116 on the lighting unit. In order for the switching surface to apply a force to the cam surface 116, the lighting unit 84 as a whole needs to be prevented from moving axially away from the switching surface 120. This may be achieve, for example, by providing an end wall 122 to the rear bearing portion 82 which is arranged to abut against the rear end of the rear axle portion 92 and prevent movement of the lighting unit 84 away from the switching surface 120. Clearly other ways of preventing axial movement of the lighting unit can be used.

Referring to FIG. 7, a cover 130, which need not be a separate component as shown, may be provided over the light-receiving cavity 50 and may have an aperture 132 in it exposing a part of the outer wall 94 of the lighting unit 84. The lighting unit 84 may form a thumb wheel that can be easily rotated by a user pressing on the exposed part of the outer wall 94 and pushing it in either of the directions of rotation of the lighting unit 84.

In operation, when the lower part 118 of the cam 114 is opposite the switching surface 120, the switching surface 120 is clear of the cam 114 and so the two annular walls 96, 98 of the lighting unit are not pressed together. The switching contact 112 is therefore clear of the terminal 113 of the battery pack and the electrical circuit is open and the light is not lit. This is therefore an ‘off’ position of the lighting unit 84. If the lighting unit 84 is rotated so that the raised part 117 of the cam 114 is opposite the switching surface 120, then the switching surface pushes the cam 114, and therefore also the front wall 96, inwards towards the rear wall 98. This brings the switching contact into contact with the terminal 113 of the battery pack, which closes the circuit and lights the bulb. Light from the bulb is transmitted through the translucent side wall 46 of the vial cavity and illuminates the vial. This is therefore an ‘on’ position of the lighting unit.

It will be appreciated that may details of the embodiments shown in the drawings may be modified in various ways which will be apparent to the skilled man, and the embodiments shown are purely as non-limiting examples of how the invention can be put into practice.

For example in one modification the light may be provided on the rim of the rotatable lighting unit rather than in one of the ends. When the lighting unit is located within a spirit level the lighting unit may be orientated so that that outer wall of the lighting unit faces towards the vial.

1. A lighting unit for a tool or instrument, the unit comprising:
a housing,
a battery within the housing,
a bulb, and
an electrical circuit, which is within the housing and connects the bulb to the battery, the housing having a switching portion, and a part of the circuit being mounted on the switching portion such that the switching portion can be moved to open and close the circuit, and a mounting means arranged to mount the housing for rotation about an axis of rotation.

2. The lighting unit according to claim 1, wherein the housing comprises an outer wall which extends round the axis of rotation.

3. The lighting unit according to claim 1, further comprising two parallel coaxial axle portions each of which is arranged to be rotatably supported in the tool or instrument.

4. The lighting unit according to claim 3, wherein the bulb is housed in one of the axle portions.

5. The lighting unit according to claim 1, wherein the switching portion has a cam formed thereon and having a cam surface which can be pressed to close the circuit.

6. The lighting unit according to claim 1, wherein the switching portion is movable between a first position in which it opens the circuit and a second position in which it closes the circuit.

7. A tool or instrument comprising a body and a lighting unit, wherein the lighting unit is a lighting unit according to claim 1.

8. The tool or instrument according to claim 7, wherein the body defines an opening into which the lighting unit can be removably inserted, and the opening is shaped so as to support the lighting unit when it is inserted into the opening.

9. The tool or instrument according to claim 7, wherein the switching portion is arranged to be frictionally retained in each of the first and second positions.

10. The tool or instrument according to claim 7, wherein the switching portion is spring biased towards the first position.

11. A tool or instrument according to claim 7, wherein the housing is movably mounted in the body so as to be movable between a first position and a second position, and the body comprises a switching surface arranged to act on the switching portion to close the circuit when the housing is in the second position.

12. The tool or instrument according to claim 11, wherein the switching portion of the housing has a housing cam surface formed thereon which is arranged to be acted on by the switching surface as the housing is moved from the first position to the second position, thereby to close the circuit.

13. The tool or instrument according to claim 11, wherein the switching surface is shaped to form a stationary cam surface and the switching portion has a contact surface thereon which is arranged to be acted on by the stationary cam surface as the housing is moved from the first position to the second position thereby closing the switch.

14. The tool or instrument according to claim 7, wherein the housing is rotatably mounted in the body and arranged to rotate between the first position and the second position.

15. The tool or instrument according to claim 14, wherein the housing is rotatable about an axis of rotation and has an outer wall which is curved around its axis of rotation.

16. The tool or instrument according to claim 15, wherein a part of the curved outer wall is exposed so that the housing can be rotated between the first and second positions by pushing the outer wall.

17. tool or instrument according to claim 15, wherein the housing further comprises a side wall which forms the flexible portion.

18. A spirit level, the spirit level comprising:
a body,
a bubble vial mounted in the body, and
a lighting unit, wherein the lighting unit comprises a housing, a battery within the housing, a bulb, and an electrical circuit which is within the housing and connects the bulb to the battery, the housing having a switching portion, and a part of the circuit being mounted on the switching portion so that the switching portion can be moved to open and close the circuit.

19. The spirit level according to any claim 18, wherein the housing is slidably mounted in the body and arranged to slide between the first position and the second position.
